(19) United States
(12) Patent Application Publication
(10) Pub. No.: US 2007/0037432 A1
(43) Pub. Date: Feb. 15, 2007

(54) Built up printed circuit boards

(76) Inventors: Jayne L. Mershon, Portland, OR (US); William O. Alger, Portland, OR (US); Gary B. Long, Aloha, OR (US); Gary A. Brist, Yamhill, OR (US); Michael W. Beckman, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/202,485

(22) Filed: Aug. 11, 2005

(51) Int. Cl. H01R 13/62

(52) U.S. Cl. 439/329

(57) ABSTRACT

A method for forming a multilayer substrate from two or more constituent substrates and an interface material. Electrically conductive or nonconductive features may be formed into the interface material and registered to electrically conductive or nonconductive features at the surface of at least one of the constituent substrates. Thereby, electrical communication may be provided between conductive features of the constituent substrates and the interface material.

### FIELD OF THE INVENTION

The present invention relates generally to the field of printed circuit board manufacturing. In particular, the present invention relates to forming electrical and mechanical interconnections in printed circuit boards.

### BACKGROUND OF THE INVENTION

Electronic devices, including consumer goods such as personal computers, video cassette recorders and digital cameras, and industrial equipment such as electrical testers, robotic assembly equipment, and missile control systems, typically comprise assemblies of numerous electronic components. The various components within such devices each fulfill a particular function useful to the proper functioning of the device as an integrated whole. In most cases, the various components must be provided with a means for electrically communicating with other components within a device, enabling their integrated functions to achieve the desired overall functional purposes of the device.

Typically, electronic components are assembled to a substrate, (e.g. a printed circuit board, or printed wiring board, hereinafter ”PCB”) wherein conductive pathways on the surface of the substrate, or formed within the substrate, provide electrical communication between the electronic components. In some instances, electrical pathways formed within the substrate may provide electrical communication laterally from one location on one exterior plane of the substrate to another location on the same exterior plane of the substrate. In other instances, the pathways may electrically couple a location on one exterior plane of the substrate to a location on the opposing exterior plane of the substrate. In still other cases, electrical communication is provided from a location on one exterior surface of a substrate to an electrical pathway formed (‘buried’) at an interior plane somewhere between the two exterior planes of the substrate.

Frequently, electrical pathways that traverse from one plane of a substrate to another plane are formed as vias. Numerous via configurations are known in the art. One such example is the ‘through via’, which traverses completely through a substrate from one exterior plane to an opposing exterior plane. Another example is the ‘blind via’, which traverses from one exterior plane of a substrate to an interior plane of the substrate, but does not emerge at the opposing exterior surface.

When forming an electrically conductive pathway between an exterior plane and an interior plane of a substrate, one can choose to use either a through via or a blind via. Each choice, however, presents significant considerations for mass manufacturing low-cost, high performance integrated electrical devices. When using through vias to provide such electrical communication between an exterior plane and an interior plane, that portion of a via not in the immediate path between the two electrically communicating planes is known as the via ‘stub’. This ‘stub’ creates a resonance in an electrical signal communicated along the electrical pathway so formed, leading to detrimental loss in the signal, as shown in FIG. 1. Further, the amount of loss is affected by the length of the unused via stub, so that a longer stub creates a higher loss, and a more detrimental result. Thus, although through vias may be formed relatively inexpensively, they may also provide an undesirable impact upon the electrical performance of an electrical device.

The presence and detrimental effects of via stubs currently may be avoided by using blind vias to create electrical pathways between exterior and interior planes, however, blind vias are not without their own challenges. Current methods for forming blind vias are expensive, and contribute to a higher overall manufacturing cost for an integrated electrical device incorporating a substrate formed with blind vias.

Via stubs may also be eliminated from through vias by a process known as ‘back drilling’, wherein the unused portion of a through via is removed by drilling into the via from the side of the substrate proximate the stub, removing the metal plating on the inner surface of the via unnecessary for electrical connection between the two involved planes, thus removing the conductive ‘stub’ that causes signal resonance. As may be understood, the added cost to perform this process properly is detrimental to the goal of low cost PCB manufacturing, and may also lead to defects within the remaining via structure.

Manufacturing cost is a concern in the market for such devices, and small increases in the overall cost of a device can have a significant impact in how effectively the seller of such a product can compete in the relevant market. This has historically been an especially notable consideration for low layer count printed circuit board substrates or other relatively inexpensive substrates where the added cost of removing via stubs or forming blind vias may comprise a larger portion of the overall manufacturing cost than it would be in a higher layer count substrate. Low layer count substrates have typically been used in electronic devices sold into the very cost conscious consumer market, whereas higher layer count substrates may be used more in products designed for more industrial applications or the commercial market, (e.g., servers, etc.). Recently, however, consumer products have become more complex, and higher layer count PCBs have made their way into the products for these cost conscious buyers.

Product designers have, to some extent, attempted to compensate for the resonance effects of via stubs in other areas of product design. However, as performance specifications become more stringent in each sequential generation of products, such compensation becomes increasingly difficult, particularly for products incorporating higher layer count substrates.

### BRIEF DESCRIPTION OF THE DRAWINGS

FIG. 1 is a graph showing the results of modeling of signal loss due to via stubs.

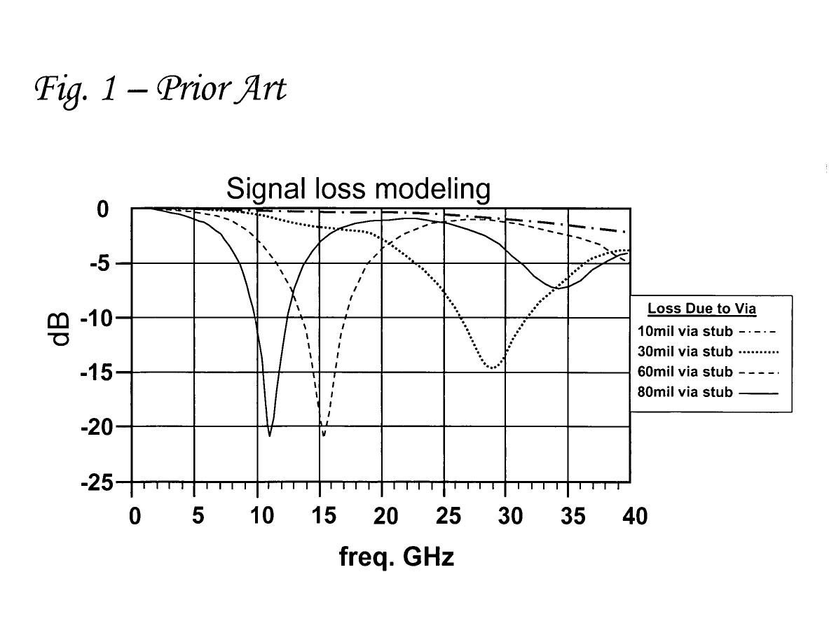

FIG. 2 depicts a cross-sectional view of two constituent substrates formed according to embodiments of the invention.

FIG. 3 depicts a cross-sectional view of a multi-layer substrate formed with an interface material according to embodiments of the invention.

FIG. 4 depicts a cross-sectional view of a multi-layer substrate formed with an interface material according to embodiments of the invention.

FIG. 5 depicts a cross-sectional view of a multi-layer substrate formed with an interface material according to embodiments of the invention.

FIG. 6 depicts a block diagram of a method for forming a multi-layer substrate according to embodiments of the invention.

FIG. 7 depicts a block diagram of a method for forming a multi-layer substrate according to embodiments of the invention.

### DETAILED DESCRIPTION OF THE INVENTION

Applicants will herein disclose numerous embodiments of a method for forming a higher layer count substrate from a plurality of lower layer count substrates, whereby electrical communication may be provided between separate planes of a substrate. Applicants will also describe embodiments of an apparatus so formed and embodiments of an assembly incorporating embodiments of an apparatus so formed.

For purposes of clarity and concision throughout this description, applicants will describe embodiments of the invention as applied to a printed circuit board, or ‘PCB’, as a representative substrate. Likewise, the exemplary embodiment of an eight layer substrate will be used herein for convenience. However, one of ordinary skill in the art would recognize that the invention is not limited in applicability to only PCBs, nor only to eight-layer substrates, but may also provide benefits in other substrates wherein electrical communication is provided between planes of a substrate. While it is appreciated that a plurality of individual PCBs (hereinafter ‘constituent PCBs’) could be combined by the described embodiments to form a single higher layer count PCB, two four-layer PCBs shall be described forming an eight-layer PCB as an exemplary embodiment in this specification. Throughout this description, ‘vias’ refers to an exemplary embodiment as plated vias, except where otherwise specifically identified as being unplated. The invention, however, is not so limited, and may include other types of vias as are known in the art.

Applicants recognize there is a great degree of variation in the particular equipment, chemicals, processing recipes and other such details (collectively, “processing”) used in substrate manufacturing worldwide. Applicants also recognize that the disclosed embodiments may be achieved, and may provide tangible benefits, although implemented by different equipment processing from any herein recited. Therefore, the disclosed embodiments should not be construed as limited to only the exemplary equipment or processing specifically mentioned in this description.

By embodiments of a method herein described, electrical communication may be provided between an exterior plane and an interior plane of a multi-layer PCB, wherein the detrimental resonance caused by the stub portion of a through via may be minimized or entirely avoided, at a lower manufacturing cost as compared to the cost of forming blind vias. Additionally, through hole vias may be formed for electrical communication between conductive features or planes on opposing surfaces of a substrate.

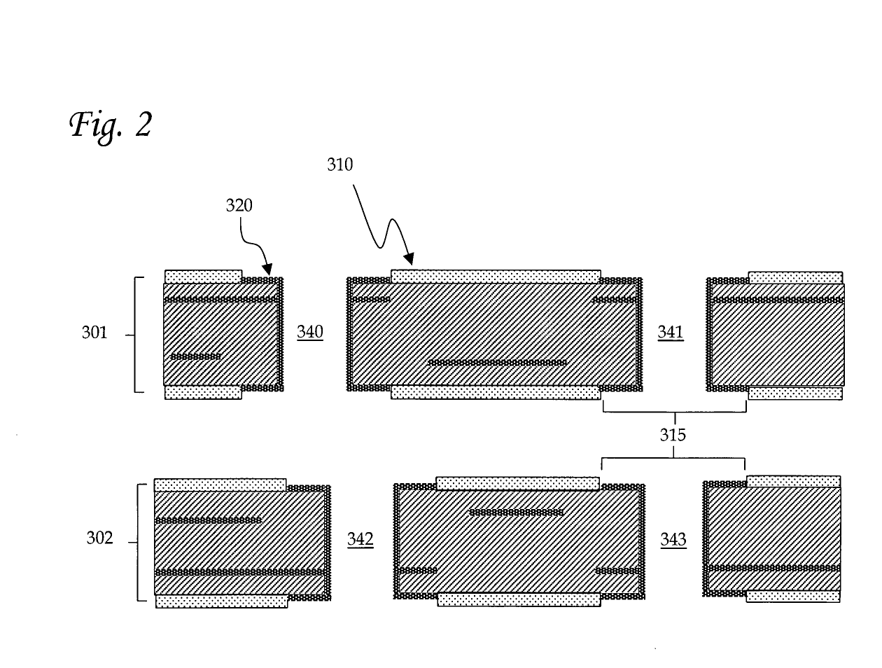

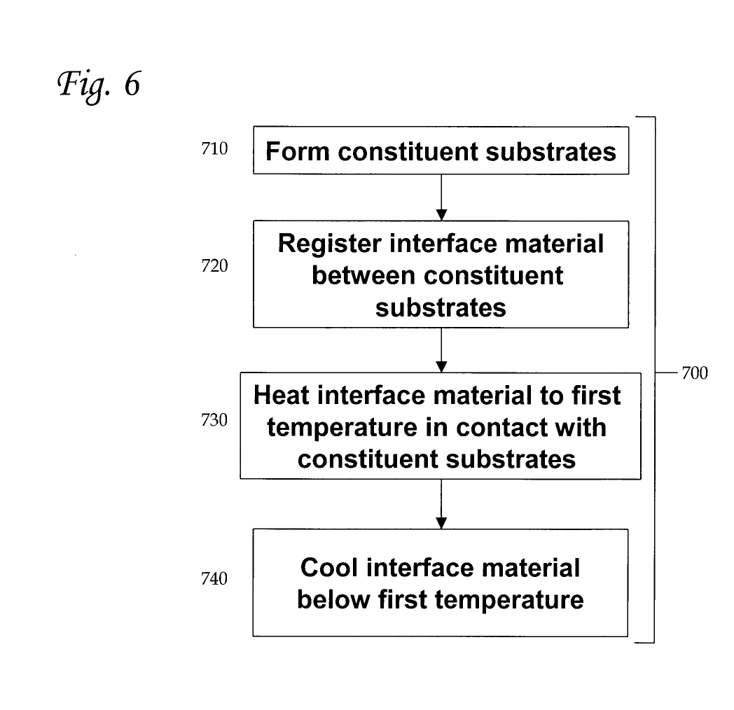

With reference to FIGS. 2 and 6, in an exemplary embodiment, a process 700 is provided in which two 4-layer constituent PCBs 301, 302 are fabricated at 710. Immersion gold, bare copper, or some other surface finish may be used according to various embodiments. PCBs 301,302 may typically include a layer of solder mask 310 on exterior surfaces with openings 315 provided in the solder mask 310 to allow electrical connection to conductive features 320 on or through the surface of the PCBs 301, 302. Alternately, openings 315 in the soldermask 310 may provide a location for physical attachment between the surface material of an exterior plane of the substrate and an extrinsic material or component without the soldermask 310 interceding.

The constituent PCBs 301, 302 may be designed so that the locations of soldermask openings 315 on an exterior plane of one constituent PCB relate to those on a reciprocal exterior plane on another PCB when the two constituent PCBs are properly aligned (‘registered’) with one another. Registering may include aligning designated markings or dimensional features on one of the constituent PCB with designated features on another constituent PCB. Registering may also include aligning functional elements on a constituent PCB with those on another constituent PCB. Occasionally, registering may include aligning each constituent PCB to some other device, such as an interface material as in embodiments of the invention, or a jig, fixture, tool, equipment, or some similar apparatus.

In one of several embodiments, one or more of vias 341, pads, exposed traces, soldermask openings or other features on the exterior plane of one constituent PCB 301 are directly registered to a like or reciprocal feature(s), such as a via 343 on a reciprocal exterior surface of another constituent PCB 302. Such registration provides for substantially the entire surface area or circumference of a feature on one constituent PCB to align with substantially the entire surface area or circumference of a reciprocal feature on another constituent PCB. By such alignment, the maximum possible surface area on each feature is available for electrical communication, physical contact, bonding attachment, or other purposes. The described registration may include in separate embodiments conductive features such as via-to-via or pad-to-pad alignment, non-conductive features such as unplated via-to-unplated via registration, or a combination of conductive and non-conductive features such as via-to-soldermask. Examples of vias that may be registered in various embodiments may include variations in structure or dimension, such as microvias or vias as part of a via-in-pad structure, or in manner of formation, such as mechanically drilled vias or laser-formed vias, and others as are known in the art.

In embodiments, conductive features on one constituent substrate, such as via 340, may be offset from conductive features on another constituent substrate, such as via 342. As will be discussed later, offset vias 340, 342 may be electrically coupled to each other or they may be electrically isolated from each other, according to various embodiments.

Rather than forming a PCB and attempting to resolve the via stub resonance problem according to prior art methods, the method herein described involves fabricating two four-layer constituent PCBs 301, 302. Then, in embodiments, reciprocal exterior surfaces of the constituent PCBs are registered to each other, brought into physical proximity with each other, and provided physical attachment sufficiently durable to maintain reliable electrical communication between reciprocal conductive features on the constituent PCBs.

In embodiments of the invention, an interface material provided between and likewise registered, at 720, to the reciprocal surfaces of the constituent PCBs may electrically or physically couple the constituent PCBs. Embodiments may include using a thermoset material, while in other embodiments, a thermoplastic material may be used.

The interface material may be formed as a flexible sheet or film to be inserted between constituent PCBs, with the holes already formed and filled with conductive material, with holes formed but not filled with conductive material, or with no holes formed into it. When the interface material is provided to a user by a manufacturer without holes or without conductive material in the holes, the user may form the holes and fill them with conductive material according to their needs. In other embodiments, the interface material may be formed as a rigid sheet, which, as may also be true for a flexible sheet or film, may be precut to the required dimensions. In still other embodiments, the interface material may also be directly deposited as a paste or liquid onto a constituent PCB, and then processed to form holes and conductive fill material. Such processing may include spinning, leveling, wiping or other methods to create a layer of sufficiently uniform spread and thickness. Processing may also include exposure to an energy source, such as heat or light, or it may include exposure to a chemical fixing or curing agent, to form an interface material of appropriate consistency (e.g. density, viscosity, moisture content).

In an embodiment, the design information for the constituent PCBs may be used to form the interface material with conductive or non-conductive areas formed into it corresponding to reciprocal conductive or non-conductive features on the constituent PCBs. The conductive or non-conductive areas in the interface material may be formed by the manufacturer of the interface material, or they may be later formed by the user of the interface material during manufacturing of a product incorporating the interface material. For example, holes may be formed into an interface material, and the holes may be filled with a conductive material. In embodiments, the conductive material may include solder, metallic paste (e.g. solder paste), conductive polymers, a mixture of conductive particles (e.g. solder particles) and epoxy, or similar conductive materials. When the interface material is deposited between the constituent PCBs as a liquid or paste, registering the interface material to a constituent PCB may entail forming holes into the interface material in alignment with conductive or non-conductive features on a constituent PCB according to the design information.

Conductively filled holes may be located within an interface material according to the constituent PCB design information so that, when placed between and registered to the constituent PCBs, a conductive pathway is formed between reciprocal conductive features on the reciprocal surfaces of the constituent PCBs through a material provided in a conductively filled hole of the interface material. Likewise, the absence of a conductively filled hole between reciprocal conductive features on the reciprocal surfaces of the constituent PCBs may hinder or prevent electrical communication between the constituent PCBs when the interface material itself is non-conductive. In an embodiment, a hole may be formed in the interface material, the hole not being filled with a conductive material but remaining unfilled.

To bond the properly registered ‘PCB-interface material-PCB’ assembly into a single, integrated substrate, in an embodiment, the interface material may be heated, at 730, to or above a first temperature sufficient to melt the interface material and cause it to reflow. This heating may be accomplished in a reflow oven, or in another embodiment, the assembly may be placed on, between, or in sufficient proximity to a heat source so that heat is transferred through the constituent PCB(s) raising the interface material to or above its melting temperature and causing it to reflow. Exposure to infrared or laser energy sources, or other methods for providing sufficient heat as are known in the art may likewise be used, provided the interface material can be substantially uniformly reflowed.

In embodiments, the interface material may have a relatively high melting temperature, or it may have a relatively low melting temperature. Considerations such as subsequent assembly activities, usage environment and others, wherein the assembly containing the interface material may become exposed to elevated temperature, may suggest use of an interface with a particular minimum melting temperature. For example, elevating the temperature of the interface material in a finally assembled electronic device beyond the melting temperature of the interface material during normal use may cause the interface material to reflow, leading to device failure. Therefore, if such a device is to be used in an elevated temperature environment, an interface material may be used that has a melting temperature higher than the maximum expected temperature of the usage environment. Likewise, if the product generates heat during normal use, one may select an interface material with a melting temperature higher than the maximum temperature the product is expected to cause the interface material to attain.

Elevated temperatures are common in electronic device assembly processes as components are soldered to PCBs through wave solder processes, reflow ovens, or even manual or automated soldering operations. As these processes may cause the interface material to melt and reflow if they exceed its melting temperature, an appropriate interface material should be used to minimize or prevent melting the interface material. Conversely, the selection of a particular interface material could, in some instances, suggest an appropriate method of device assembly so as to avoid undesirable reflow within the interface material. For example, manual soldering maybe be used in some instances rather than a reflow oven. In embodiments, it may be acceptable for the interface material to soften during assembly, but it may be unacceptable for the interface material to so substantially melt that it begins to reflow. In other embodiments, the component assembly heating may be used to reflow the interface material, obviating the need for multiple separate reflow activities; one for the interface material and one for the components. In still other embodiments, the constituent PCBs may already have components assembled to them prior to assembling them with the interface material.

After heating the interface material causing it to reflow, the interface material is allowed to cool, at 740, below the first temperature, adhesively or mechanically bonding the constituent PCBs together, and where designed to do so, forming durable electrically conductive pathways between the reciprocal electrically conductive features of the constituent PCBs via conductively filled holes in the interface material.

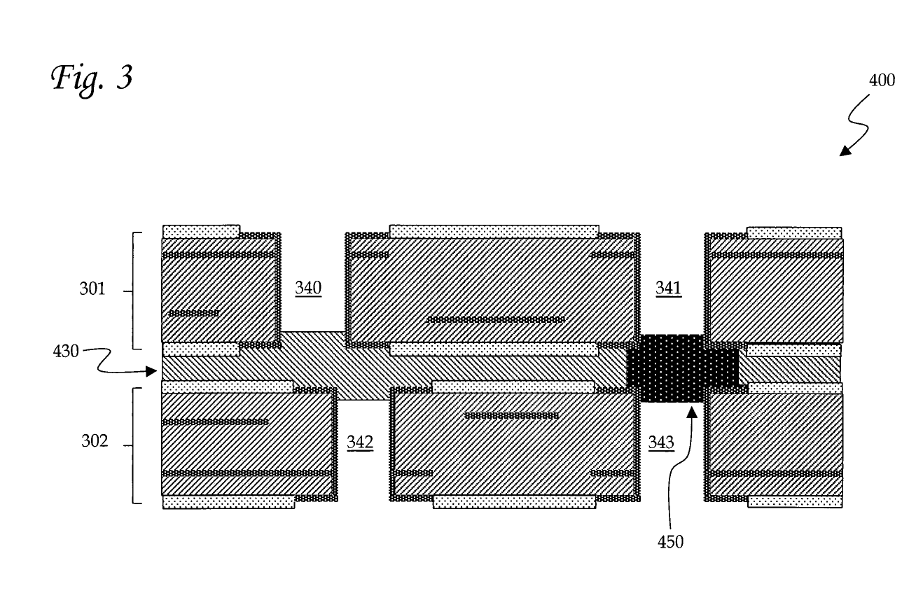

In an embodiment substantially depicted in FIG. 3, the vias 341, 343 of reciprocal constituent PCBs 301, 302 may be blocked by a conductively filled hole 450 in the interface material 430, providing electrical communication through the assembly 400 from a via of one constituent PCB 301 to a via of another constituent PCB 302.

However, in an embodiment where non-conductive interface material 430 is present between vias 340, 342, electrical communication is prevented between the vias of the constituent PCBs 301, 302. In this embodiment, the non-conductive interface material 430 blocks each of the through vias 340, 342 creating blind vias. Blind vias may also be formed in an embodiment in which the through vias 540, 542 of the constituent PCBs may align with an unfilled hole 535 in the interface material 530. In such an embodiment, the vias of the constituent PCBs are not electrically coupled to each other through the unfilled hole in the interface material.

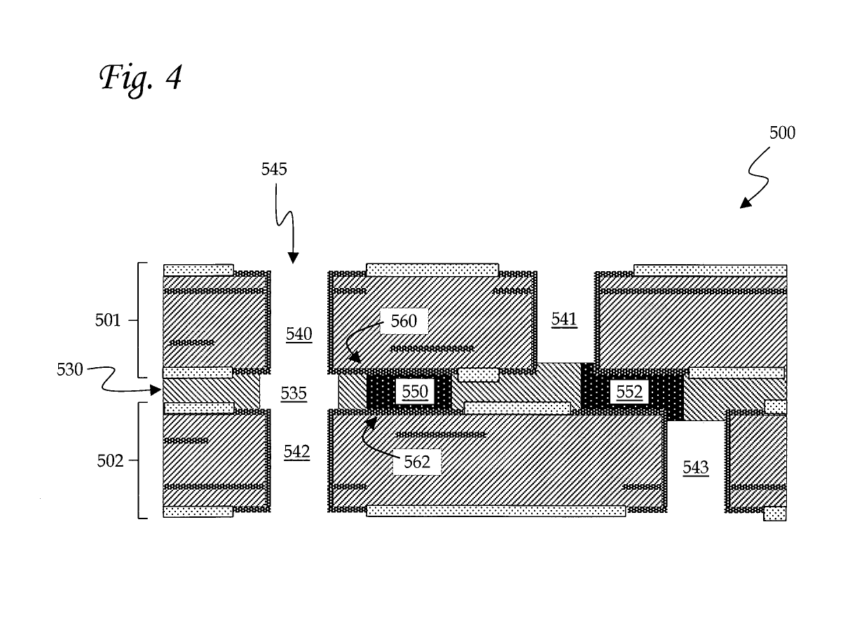

In another embodiment, as substantially shown in FIG. 4, while a conductively filled hole 550 in the interface material 530 may not be provided in alignment with the through vias 540, 542, it may be provided in alignment with conductive pads 560, 562 on the reciprocal surfaces of the constituent PCBs 501, 502, the pads 560, 562 being connected to the vias 540, 542 by electrical pathways, such that the via 540 of one constituent PCB 501 is electrically coupled to the via 542 of another constituent PCB 502 through the reciprocal conductive pads 560, 562 and the conductively filled hole 550 in the interface material 530. In this case, a through via may be formed. In one such embodiment, at least one of the conductive pads may partially or entirely surround the via opening. In another embodiment, at least one of the conductive pads may be substantially offset from the via or from a conductive pad surrounding the via, and may be connected to the via or the conductive pad surrounding the via by means of a conductive pathway formed upon at least one of the inner and outer planes of the PCB. Thus, directly aligned vias may be provided in constituent PCBs joined together by an interface material, wherein the vias may either be electrically coupled to each other, or alternatively, may be electrically isolated from each other. Vias may be aligned with an unfilled hole in the interface material, so that there is an unobstructed passage through from the exterior surface of one constituent PCB to the opposing exterior surface of another constituent PCB. Alternatively, a via may be blocked by either a conductively filled hole in the interface material, or by the interface material itself where no hole is present.

It should likewise be understood that vias need not be directly aligned in all embodiments of the invention. In an exemplary embodiment, vias 541, 543 in the two constituent PCBs 501, 502 may be offset from each other so that they do not align, or only partially align, when the constituent PCBs 501, 502 are properly registered. Yet, in various embodiments, as with aligned vias, a conductively filled hole 552 in the interface material may provide electrical communication between the offset vias. In one such embodiment, the conductively filled hole 552 may be provided so that it fully or partially overlaps both vias 541, 543. In another embodiment, the conductively filled hole may overlap a via in one constituent PCB, and while not overlapping a via in the other constituent PCB, it may overlap a conductive pad or other feature that is electrically coupled to a via on another constituent PCB. In another embodiment, the conductively filled hole may not overlap the vias of either constituent PCB, but may overlap conductive pads or other features on both constituent PCBs, which are in turn electrically coupled to vias in each constituent PCB. Thus, as described, electrical communication may be provided between non-aligned (off-set) vias by a conductively filled hole in the interface material.

Just as a conductively filled hole in the interface material may provide electrical communication between conductive pads on two constituent PCBs, wherein one or more of the conductive pads are electrically coupled to a conductive via in a PCB, likewise, conductively filled holes in the interface material may also provide electrical communication between conductive pads on constituent PCBs that are not closely adjacent to a conductive via. One exemplary embodiment may include conductive pads located at the terminal ends of conductive traces wherein the traces begin and end on one plane of the PCB without traversing to another plane through a via.

It should be understood from the described embodiments that conductive features such as, but not limited to vias and pads may be electrically coupled through conductively filled holes in the interface material. However, other conductive features presented to the external surface of constituent PCBs may be likewise electrically coupled. For example, an embodiment may include holes in the solder mask on a constituent PCB located directly over a portion of a conductive trace (wire line), registered to a conductively filled hole in the interface material so that the conductive trace of one PCB may be electrically coupled to a conductive feature on another constituent PCB. Likewise, a conductively filled hole in the interface material may be electrically coupled to a conductive feature, such as a terminal, on a component embedded into the surface of a constituent PCB. Examples of components in such embodiments might include capacitors, resistors or others that may be embedded into the surface of a PCB as known in the art. In other embodiments, a conductively filled hole in the interface material may be electrically coupled directly to a power plane or a ground plane of a constituent PCB through an opening formed into the surface of the constituent PCB.

As would be understood in each of the foregoing described embodiments, heating, reflowing, and reforming the interface material while disposed between two constituent PCBs will create a single integrated assembly, wherein the constituent PCBs form the outer layers, and the interface material forms an inner layer in direct contact with and bonded to a surface of each of the PCBs. However, it should be well understood that in separate embodiments, the number of constituent PCBs and interface material layers may be greater than in those embodiments already described. Thus, in an exemplary embodiment, three constituent PCBs, each comprising four layers, may be joined together by two layers of interface material to create a single assembly of PCB-interface-PCB-interface-PCB, comprising any or all of the via configurations already described. While a single integrated assembly comprising two or more constituent PCBs may be aligned and bonded together with interface material as described in a single operation, it should also be understood that it may be useful to bond two PCBs together with interface material as described, then later additionally join PCB/interface layers to sequentially increase the number of overall layers in a single integrated assembly. Each approach may be selected based upon goals for production efficiency, specifications, tolerances, equipment limitations, or numerous other considerations. However, such variations are included by, and do not depart from the spirit of the described embodiments.

Following the bonding together of the constituent PCBs with the interface material as described above, further production processes may then be performed as need. These may include trimming the joined assembly to a final size, conducting quality testing and performance testing, attaching components, or other operations as may be undertaken to prepare a product for its designated purpose.

Thus, in numerous embodiments, a high layer count PCB-based substrate may be formed from two or more constituent PCBs, each having fewer layers than the formed PCB. In each of the preceding embodiments, wherein a conductive pathway is formed from a conductive feature on one constituent PCB to a conductive feature on a second constituent PCB, the conductive pathway is formed by a conductively filled hole in the interface material.

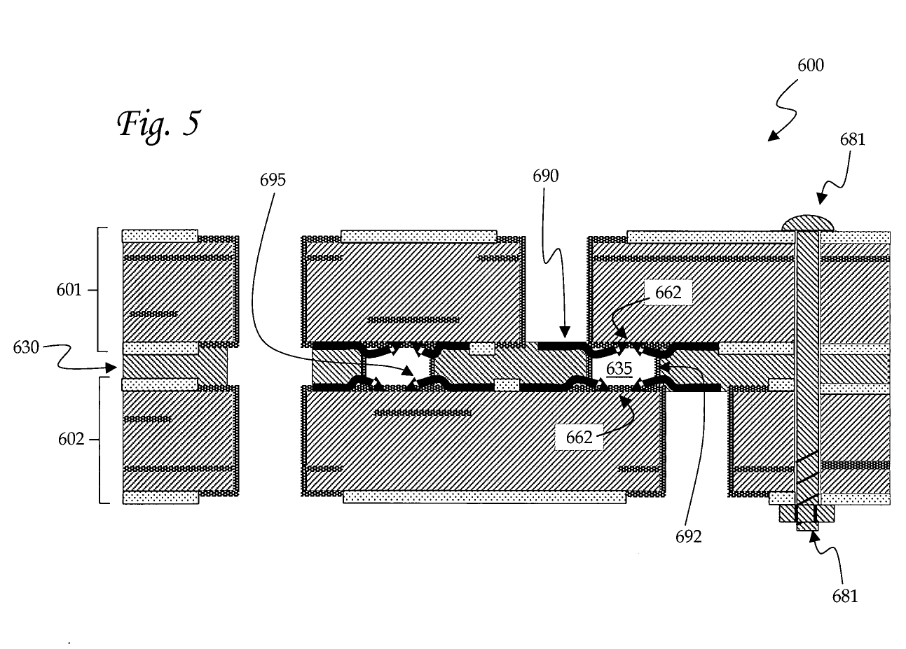

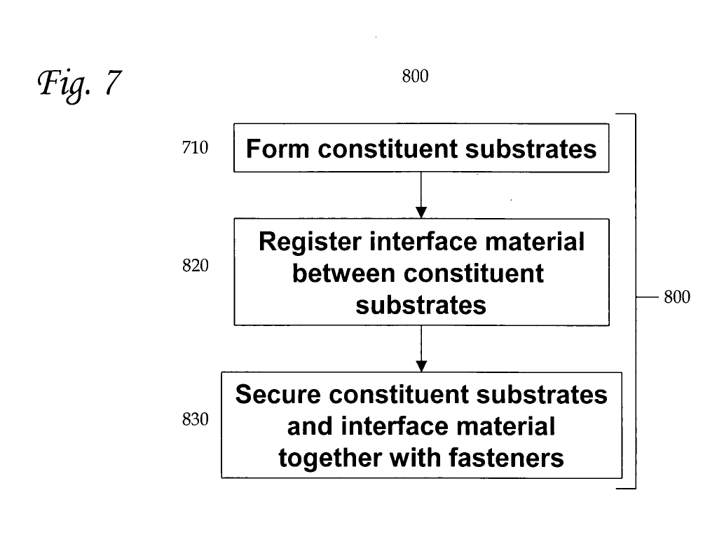

In other exemplary embodiments of the invention depicted in FIGS. 5 and 7, a process 800 is provided in which a higher layer count PCB 600 may also be formed from two or more constituent PCBs 601, 602 and an interface material 630 by a mechanical connection using tooling rather than by melting and reforming the interface material. An interface material 630 may comprise in part, according to an exemplary embodiment, a copper clad layer 690 etched to form conductive copper extensions, or ‘prongs’ 695. Although copper is used in this specification for exemplary purposes, an interface material 630 may be clad in other conductive metals according to alternate embodiments. Prongs 695 may protrude into holes 635 formed into the interface material 630, and may be formed so that they may make contact with a conductive feature 662 on the surface of a constituent PCB 601, 602 when such is brought into contact with a surface of the interface material 630. In some embodiments, a prong ‘protruding’ into a hole 635 may include some portion of the prong actually being located within the physical dimensions of a hole 635. In other embodiments, a prong ‘protruding’into a hole 635 may include a portion of a prong crossing over a boundary defined by the outer perimeter of a hole 635 and extending (overlapping) into the space ‘over’ the hole.

As mentioned, a cladding layer 690 may comprise conductive materials other than copper that may provide benefits. Therefore, other embodiments may include cladding layers with prongs formed from conductive materials other than copper. The design information used to produce the constituent PCBs 601, 602 may be used or modified for use in manufacturing the interface material 630 so that the holes 635 and conductive copper prongs 695 in the interface material 630 will register with at least one conductive feature 662 on a surface of at least one of the constituent PCBs 601, 602. A hole 635 in an interface material 630 may be conductively filled, as in other embodiments, or it may be plated 692, and the conductive filling or plating 692 so formed may be electrically coupled to conductive prongs 695 on both sides of the interface material, so that a conductive prong 695 on one side of the interface material may be electrically coupled to a conductive prong on the other side of the interface material 630.

In embodiments, a first prong electrically coupled to a first conductive feature on a first constituent PCB may be electrically coupled via a conductive pathway (e.g. a conductive trace) to a second prong, the second prong being on the same surface of the interface material as the first prong, the second prong being electrically coupled to a second conductive feature on the same surface of the first constituent PCB as the first conductive feature. In other embodiments, the first prong may be electrically coupled to a first conductive feature on a first constituent PCB, then electrically coupled through a conductive pathway in the interface material (e.g. a plated via, a conductively filled hole) to a second prong on the opposite side of the interface material, the second prong being electrically coupled to a second conductive feature on the second constituent PCB.

With reference to FIG. 7, as with prior embodiments, two constituent PCBs 601, 602 may be formed, at 810, and then joined together with an interface material layer 630 interposed between them, the interface material 630 registered, at 820, to at least one of the constituent PCBs 601, 602. Registering may include aligning a conductive feature 662 on the surface of a constituent PCB 601, 602 with a corresponding conductive feature 662 on the reciprocal surface of the interface material 630. Registering may also include aligning a non-conductive feature on the surface of one of either a constituent PCB 601, 602 or the interface material 630 with a conductive feature on the other of the constituent PCB 601, 602 or the interface material 630. In still another embodiment, registering may include aligning non-conductive features on the surfaces of a constituent PCB 601, 602 and the interface material 630. An example of a non-conductive feature might include an alignment fiducial or similar feature printed onto a substrate or embedded within it.

The constituent PCBs 601, 602 and the interface material 630 may be secured together, at 830, using mechanical tooling 681 rather than by melting and reforming the interface materials. Mechanical tooling 681 for this purpose may include fasteners such as screws, nuts and bolts, clips, rivets, locking pins, frames, platens, a substrate retention unit of an electrical device or other such fixtures or fastening devices as are known in the art, or any combination thereof. For convenience herein, mechanical tooling 681 that may be used according to embodiments of the invention are collectively referred to as ‘fasteners’. A substrate retention unit of an electrical device may include a chassis to which a substrate is affixed as part of an assembled device (e.g., a computer chassis), a clamping mechanism, a slot in a rack mounting arrangement (e.g. a board rack in a blade server), a cam locking retainer, or other arrangements for retaining a substrate as part of an electrical device. Electrical devices as recognized in embodiments of the invention, include any device in which a multi-layer substrate is a constituent part, and which operate at least in part on electrical power, whether the electricity originates from some external source or is generated or altered to some degree within the device itself. Typically these will include assembled electrical (or ‘electronic’) devices.

Primarily, fasteners 681 will durably hold the constituent PCBs 601, 602 in close physical proximity and alignment so that proper registration and electrical communication are maintained, and proper use and function is not impaired. Thus, the dimensions and placement of the fasteners 681 must not interfere with equipment or tools used for handling the completed higher layer count substrate prior to or during its intended use, nor with component placement and attachment during assembly of a product incorporating a high layer count PCB formed according to embodiments of the invention.

In an embodiment, the fasteners 681 may be placed around the periphery of the formed higher layer count PCB 600, while in another embodiment the fasteners 681 may be placed at various locations within the periphery of the high layer count PCB 600 as provided for in the design and layout of the constituent PCBs 601, 602.

As would be understood by one skilled in the art, exact fastener 681 types to be used and placement of fasteners 681 within the PCB design are variable, depending largely on the objectives and capabilities of the manufacturer. Thus, a detailed listing is neither practical nor necessary here.

As may be easily understood from the described embodiments, it is advantageous for the reciprocal surfaces of the constituent PCBs 601, 602 to be substantially co-planar across all surfaces that are to provide electrical communication between the constituent PCBs 601, 602. However, in embodiments, the interface material may be sufficiently compliant to conform to surfaces which are not substantially co-planar, thus compensating for co-planarity irregularities in the reciprocal constituent PCB 601, 602 surfaces. As can be appreciated, the interface material may also be formed thickly or thinly, as may be useful and permitted for particular applications, however, a thicker compliant interface material will be able to compensate for more significant surface co-planarity irregularities than will a thinner interface material.

Likewise, the thickness of the interface material 630 may be varied to increase or decrease the overall thickness of a higher layer count PCB 600 formed according to various embodiments. Increasing or decreasing the thickness of a higher layer count PCB 600 may be beneficial by allowing use of standardized tooling in situations where the tooling imposes thickness limitations, where packaging materials may be standardized, or where other economic benefits may be similarly realized. Therefore, embodiments are included wherein the thickness of the interface material may be varied to realize various benefits.

An interface material 630 may also help prevent damage caused by thermal variation when an embodiment of the invention is formed using constituent substrates with different coefficients of thermal expansion (CTE). The interface material may provide a buffering function if it possesses a CTE intermediate between those of the constituent substrates 601, 602. Likewise, a substantially compliant interface material 630 may permit free thermal expansion of the constituent PCBs 601, 602 while maintaining reliable electrical communication between them and preventing CTE related damage, such as fracturing, delamination, and others.

Just as a compliant interface material may provide benefits, it is also recognized that fasteners 681 that allow for some compliance may also be provided according to embodiments of the invention. Thus, if the materials used in two or more constituent PCBs have different CTE values that cause the constituent PCBs to expand at different rates relative to each other, the fasteners may allow for the disparate expansion rates without causing damaging stresses to accumulate in the constituent PCBs 601, 602 or interface materials 630, without losing reliable electrical communication between the constituent PCBs and without the fasteners 681 themselves being damaged.

The foregoing detailed description and accompanying drawings are only illustrative and not restrictive. They have been provided primarily for a clear and comprehensive understanding of the embodiments of the invention, and no unnecessary limitations are to be understood therefrom. Numerous additions, deletions, and modifications to the embodiments described herein, as well as alternative arrangements, may be devised by those skilled in the art without departing from the spirit of the embodiments and the scope of the appended claims.

We claim:

1. A method, comprising:
providing at least one conductively filled hole in an interface material;
registering the interface material between a first constituent substrate and a second constituent substrate,
the registering including aligning a first conductive feature on the first constituent substrate with at least one of the conductively filled hole or a non-conductive portion of the interface material;
heating the interface material to at least a first temperature; and
cooling the interface material to below the first temperature.

2. The method of claim 1, wherein the interface material comprises at least one of a thermoset material and a thermoplastic material.

3. The method of claim 2, wherein the interface material may be registered as at least one of a rigid sheet, a flexible sheet, a film, a paste, and a liquid.

4. The method of claim 1, wherein the conductively filled hole is electrically coupled to the conductive feature.

5. The method of claim 1, wherein the conductively filled hole is filled with at least one of solder, metallic paste, conductive polymers, and a mixture of conductive particles and epoxy.

6. The method of claim 1, wherein the first temperature is at least as high as the melting temperature of the interface material.

7. The method of claim 1, further comprising registering the interface material to a second conductive feature on the second constituent substrate.

8. The method of claim 1, wherein the conductive feature comprises at least one of a pad, a via, a via-in-pad structure, a trace, an exposed power plane, an exposed ground plane, and a terminal of a component.

9. The method of claim 1, wherein at least one of the first constituent substrate and the second constituent substrate is a printed circuit board.

10. A method, comprising:
providing at least one hole in an interface material,
the interface material being clad with a conductive layer on at least a first side, the conductive layer being etched to form at least a first prong;
registering the interface material between a first constituent substrate and a second constituent substrate,
the registering including aligning the first prong with at least a first conductive feature on the first constituent substrate; and
mechanically securing the first and second constituent substrates and the interface material.

11. The method of claim 10, wherein the conductive layer comprises copper.

12. The method of claim 10, wherein a second side of the interface material is clad with a conductive layer.

13. The method of claim 12, further comprising registering at least a second prong formed on a second side of the interface material with at least a second conductive feature on the second constituent substrate.

14. The method of claim 10, wherein mechanically securing the first and second constituent substrates and the interface material comprises fastening with at least one of a screw, a bolt, a clip, a rivet, a locking pin, a frame, a platen, and a substrate retention unit of an electrical device.

15. The method of claim 10, wherein the conductive feature comprises at least one of a pad, a via, a via-in-pad structure, a trace, an exposed power plane, an exposed ground plane, and a terminal of a component.

16. The method of claim 10, wherein at least one of the first constituent substrate and the second constituent substrate is a printed circuit board.

17. The method of claim 10, wherein the first prong protrudes into the hole in the interface material.

18. The method of claim 10, wherein at least the first prong is electrically coupled to a conductive pathway provided from the first side of the interface material to at least a second prong on an opposite side of the interface material.

19. An apparatus, comprising:
an interface material interposed between a first constituent substrate and a second constituent substrate, the interface material having at least one conductively filled hole, at least one conductive feature on the first constituent substrate being registered to at least one of the conductively filled hole and a non-conductive portion of the interface material, the interface material being securely bonded to the first constituent substrate and the second constituent substrate.

20. The apparatus of claim 19, wherein the conductively filled hole is filled with at least one of solder, metallic paste, conductive polymers, and a mixture of conductive particles and epoxy.

21. The apparatus of claim 19, wherein the conductively filled hole is electrically coupled to a conductive feature on at least one of the first constituent substrate and second constituent substrate.

22. The apparatus of claim 19, wherein the conductive feature comprises at least one of a pad, a via, a via-in-pad structure, a trace, an exposed power plane, an exposed ground plane, and a terminal of a component.

23. The apparatus of claims 19, wherein at least one of the first constituent substrate and the second constituent substrate is a printed circuit board.

24. The apparatus of claim 19, wherein the interface material may be registered as at least one of a rigid sheet, a flexible sheet, a film, a paste, and a liquid.

25. The apparatus of claim 19, wherein the interface material is at least one of a thermoset material or a thermoplastic material.

26. An apparatus, comprising:
an interface material interposed between a first constituent substrate and a second constituent substrate, at least one of the first and second constituent substrates having at least one conductive feature, the interface material having at least one hole, the interface material being conductively clad on at least one side, the conductive cladding being etched to form at least one prong, the prong being registered to the conductive feature, the interface material and the first and second constituent substrates being mechanically secured together.

27. The apparatus of claim 25, wherein the prong is electrically coupled to the conductive feature on at least one of the first constituent substrate and the second constituent substrate.

28. The apparatus of claim 25, wherein the prong protrudes into the hole.

29. The apparatus of claim 25, wherein at least one of the first constituent substrate and the second constituent substrate is a printed circuit board.

30. The apparatus of claim 25, wherein mechanically securing together the interface material and the first and second constituent substrates comprises fastening with at least one of a screw, a bolt, a clip, a rivet, a locking pin, a frame, a platen, and a substrate retention unit of an electrical device.

31. An assembled electrical device, comprising:
a multilayer substrate including an interface material interposed between two substantially fully formed constituent substrates, at least one of the constituent substrates having at least one conductive feature electrically coupled to at least one of a conductively filled hole and a non-conductive portion of the interface material.

32. The assembled electrical device of claim 31, wherein the constituent substrates are bonded together by the interface material.

33. The assembled electrical device of claim 31, wherein the interface material may be registered as at least one of a rigid sheet, a flexible sheet, a film, a paste, and a liquid.

34. The assembled electrical device of claim 31, wherein the interface material includes at least one of a thermoset material and a thermoplastic material.

35. The assembled electrical device of claim 31, wherein the conductively filled hole is filled with at least one of solder, metallic paste, conductive polymer, and a mixture of conductive particles and epoxy.

36. The assembled electrical device of claim 31, wherein at least one of the constituent substrates is a printed circuit board.

37. An assembled electrical device, comprising:
a multilayer substrate including an interface material interposed between two substantially fully formed constituent substrates, at least one of the constituent substrates having at least one conductive feature electrically coupled to at least one conductive prong on the interface material.

38. The assembled electrical device of claim 37, wherein the constituent substrates and the interface material are secured together by at least one fastener.

39. The assembled electrical device of claim 38, wherein the fastener comprises at least one of a screw, a bolt, a clip, a rivet, a locking pin, a frame, a platen, and a substrate retention unit of an electrical device.

40. The assembled electrical device of claim 37, wherein the conductive prong protrudes into a hole in the interface material.

41. The assembled electrical device of claim 37, wherein the conductive feature comprises at least one of a pad, a via, a via-in-pad structure, a trace, an exposed power plane, an exposed ground plane, and a terminal of a component.

42. The assembled electrical device of claim 37, wherein at least one of the constituent substrates is a printed circuit board.
